(19) United States
(12) Patent Application Publication
(10) Pub. No.: US 2012/0281761 A1
(43) Pub. Date: Nov. 8, 2012

(54) System and Method for Macroblock Transcoding

(75) Inventors: Zhenyu Wu, Plainsboro, NJ (US); Zhang Peng, Beijing (CN); Lou Shuai, Beijing (CN)

(73) Assignee: FutureWei Technologies, Inc., Plano, TX (US)

(21) Appl. No.: 13/453,889

(22) Filed: Apr. 23, 2012

Related U.S. Application Data
(60) Provisional application No. 61/481,558, filed on May 2, 2011.

(51) Int. Cl. H04N 7/34; H04N 7/36

(52) U.S. Cl. 375/240.16; 375/E07.027; 375/E07.258; 375/E07.266; 375/E07.198

(57) ABSTRACT

An embodiment method of transcoding a macroblock coded in one of a Skip mode and a Direct mode includes recording a first reference frame index and a first motion vector corresponding to the macroblock during a decoding process and deriving a second reference frame index and a second motion vector corresponding to the macroblock during an encoding process. The method further includes comparing the first reference frame index to the second reference frame index and the first motion vector to the second motion vector during the encoding process. If the comparing achieves a predetermined criteria, the Skip mode and the Direct mode are reused to encode the macroblock during the encoding process.

This patent application claims priority to U.S. Provisional Application No. 61/481,558, filed on May 2, 2011, entitled “System and Method for SKIP/Direct Modes Treatment in Bit-Rate Reduction Transcoding,” which is incorporated by reference herein as if reproduced in its entirety.

### TECHNICAL FIELD

The present disclosure relates to image processing, and, in particular embodiments, to macroblock transcoding.

### BACKGROUND

H.264/MPEG-4 Part 10 or AVC (Advanced Video Coding) is a standard for video compression, and is currently one of the most commonly used formats for the recording, compression, and distribution of high definition video. The final drafting work on the first version of the standard was completed in May 2003.

H.264/MPEG-4 AVC is a block-oriented motion-compensation-based codec standard developed by the ITU-T Video Coding Experts Group (VCEG) together with the ISO/IEC Moving Picture Experts Group (MPEG). It was the product of a partnership effort known as the Joint Video Team (JVT). The ITU-T H.264 standard and the ISO/IEC MPEG-4 AVC standard (formally, ISO/IEC 14496-10-MPEG-4 Part 10, Advanced Video Coding) are jointly maintained so that they have identical technical content.

### SUMMARY

In an embodiment, a method of transcoding a macroblock coded in one of a skip mode and a direct mode includes recording a first reference frame index and a first motion vector corresponding to the macroblock during a decoding process, deriving a second reference frame index and a second motion vector corresponding to the macroblock during an encoding process, comparing at least one of the first reference frame index to the second reference frame index and the first motion vector to the second motion vector during the encoding process, and reusing one of the skip mode and the direct mode to encode the macroblock during the encoding process if the comparing meets a predetermined criteria.

In an embodiment a method of transcoding a macroblock coded in one of a skip mode and a direct mode includes recording a first reference frame index and a first motion vector corresponding to the macroblock during a decoding process, deriving a second reference frame index and a second motion vector corresponding to the macroblock during an encoding process, testing other modes of encoding if the first reference frame index does not match the second reference frame index, and determining if a difference between the first motion vector and the second motion vector exceeds a threshold if the first reference frame index matches the second reference frame index, and testing the other modes of encoding if the difference exceeded the threshold, and reusing the one of the skip mode and the direct mode to encode the macroblock during the encoding process if the difference failed to exceed the threshold.

In an embodiment, a transcoding apparatus for transcoding a macroblock code in one of a skip mode and a direct mode includes a processor, a storage memory, a decoding module, and an encoding module. The storage memory is operably coupled to the processor. The decoding module is loaded in the storage memory and configured to record in the storage memory a first reference frame index and a first motion vector corresponding to the macroblock during a decoding process. The encoding module is loaded in the storage memory and configured to derive a second reference frame index and a second motion vector corresponding to the macroblock, to compare at least one of the first reference frame index to the second reference frame index and the first motion vector to the second motion vector, and to reuse one of the Skip mode and the Direct mode to encode the macroblock during an encoding process if the comparison meets a predetermined criteria.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 is a flow diagram depicting an embodiment of a transcoding process;

FIG. 2 is an embodiment of a method of transcoding a macroblock coded in either a Skip mode or a Direct mode;

FIG. 3 is an embodiment of a method of transcoding a macroblock coded in either a Skip mode or a Direct mode; and

FIG. 4 is an embodiment processing system that can be utilized to implement the flow of FIG. 1 and the methods of FIGS. 2 and 3.

### DETAILED DESCRIPTION OF ILLUSTRATIVE EMBODIMENTS

The making and using of the present embodiments are discussed in detail below. It should be appreciated, however, that the present disclosure provides many applicable inventive concepts that can be embodied in a wide variety of specific contexts. The specific embodiments discussed are merely illustrative and do not limit the scope of the disclosure.

The present disclosure will be described with respect to SKIP/Direct modes treatment in bit-rate reduction transcoding (a.k.a., trans-rating), such as in H.264/AVC bit-rate reduction transcoding. The concepts of the present disclosure may also be applied, however, to other transcoding processes in general.

Video transcoding refers to the operation of converting one encoded video bitstream into another form that differs in one or multiple aspects, such as compression format, bit rate, spatial resolutions, frame rate, etc. Conceptually it includes a decoding stage followed by an encoding stage. There are different flavors of video transcoding schemes with tradeoffs in transcoding speed and output video quality. One criterion that categorizes various schemes is whether the encoding stage utilizes the information obtained during the decoding stage. For those that do, such as the transcoding scheme discussed in the disclosure, relevant information is recorded during the decoding stage and then applied during the encoding stage to either increase the coding quality and/or reduce coding complexity.

Bit-rate reduction video transcoding usually refers to a type of video transcoding operation that reduces the output bitstream bit-rate compared to the input bitstream, while maintaining the same video compression format (e.g. H.264, MPEG-2, etc.) as the input bitstream. Embodiments of the present disclosure deal in particular with the case of H.264 bi-rate reduction transcoding, which is simply referred to as transcoding hereafter. It is understood, however, that inventive concepts could also be applied to other transcoding techniques.

Special encoding algorithms are often designed in order to reduce the computational cost of transcoding, where various schemes are abundant in the literature (see e.g., H. Nam, et.al., “Low complexity H.264 transcoder for bitrate reduction,” ISCIT, 2006, and P. Zhang, et.al., “Key techniques of bit rate reduction for H.264 streams,” Advances in Multimedia Information Processing—PCM 2004, both of which are incorporated herein by reference). Simply put, these schemes extract relevant information from the input video bitstream and then apply it in some way to reduce the complexity in the encoding stage. Such examples include reusing input frame types, reference frames, and motion vectors, and so on.

When an input bitstream undergoes a bit-rate reduction transcoding, certain coded information in the output bitstream changes correspondingly, for example, quantization parameters, macroblock (MB) modes, motion vectors, and so on.

H.264 specifies a large set of coding modes in which a MB can be encoded. It improves coding efficiency, nonetheless at the cost of higher encoding complexity. Such modes include I-frames (e.g., I16×16, I8×8, I4×4, and I_PCM) and B-frames (e.g., BSkip, BDirect, B16×16, B16×8, B8×16, B8×8, B8×4, B4×8, B4×4, with the choices of L0/L1/Bi-directional predictions.

During the encoding, the encoder performs the mode decision process on a per-MB basis. The mode decision usually involves going through the list of the modes of a particular frame type, performing motion estimation, and encoding to get an estimate of the associated coding cost for each mode. Then based on the collected statistics, the encoder chooses the mode with the minimum cost as the coding mode for the MB. Because motion estimation is a computational-intensive operation, and with many modes to test, mode decision usually is the main source of complexity in a typical H.264 encoder.

Alternatively, when encoding MBs that are in a PSkip/BSkip/BDirect mode in a bit-rate reduction transcoding application, one practice is to unconditionally check additional modes, for example, P16×16 for P-frames and B16×16 for B-frames. For each additional mode candidate, the encoder has to perform motion estimation and encoding to get the estimate of the mode coding cost. Then, based on the collected statistics, it chooses the mode with the minimum cost to actually encode the MB. This conventional approach has the drawback of not fully utilizing the existing information from the input bitstream, and thus results in computational inefficiency.

However, for the concerned transcoding, certain simplification can be made regarding mode decision to reduce the coding complexity. In the Rate-Distortion Optimization (RDO) framework employed by the H.264 encoder, when encoding a MB, each mode may incur a different bit rate penalty. The penalty is proportional to the number of bits used to code the MB by a positive Lagrangian coefficient, where the bits are spent to code the mode's syntax elements and its residual signal. As the target bit rate reduces, the Lagrangian coefficient value increases and so does the rate-cost penalty. Therefore, generally it is less likely for the encoder to choose a mode with a higher syntax cost than the mode that is used in the input MB. Consequently, the encoder can safely choose only those modes with close or smaller syntax costs than the input mode. By doing so, there is only limited possibility of missing the optimum mode that affects coding efficiency, but on the other hand the encoding speed can be greatly improved.

In H.264, both the PSkip and the BSkip modes are usually used to code stationary scenes and they are signaled by only a few bits with very little syntax costs. Similarly, BDirect mode only additionally encodes residual signal and is next to BSkip in terms of syntax cost among all the available modes in B-frames. In bit rate reduction transcoding, applying the observation mentioned above, only the modes with syntax costs close to PSkip/BSkip/BDirect modes can be checked when an MB from the input bitstream is coded in one of the modes, for example, P16×16 for a P-frame and B16×16 for a B-frame.

In many cases, PSkip/BSkip/BDirect mode is still maintained after transcoding with some exceptions. The reason for these exceptions is that the reference frames and motion vectors for a MB coded in these modes are derived from its spatial/temporal neighbors. During the transcoding, if a MB is changed to a different mode, the MB may have different reference frames, motion vectors, etc., relative to neighboring MBs. Such motion information can then propagate to the nearby MBs in Skip or BDirect mode because of the derivation process. When that happens, the affected MBs have different motion information than what was originally signaled, and it can lead to severe coding artifacts.

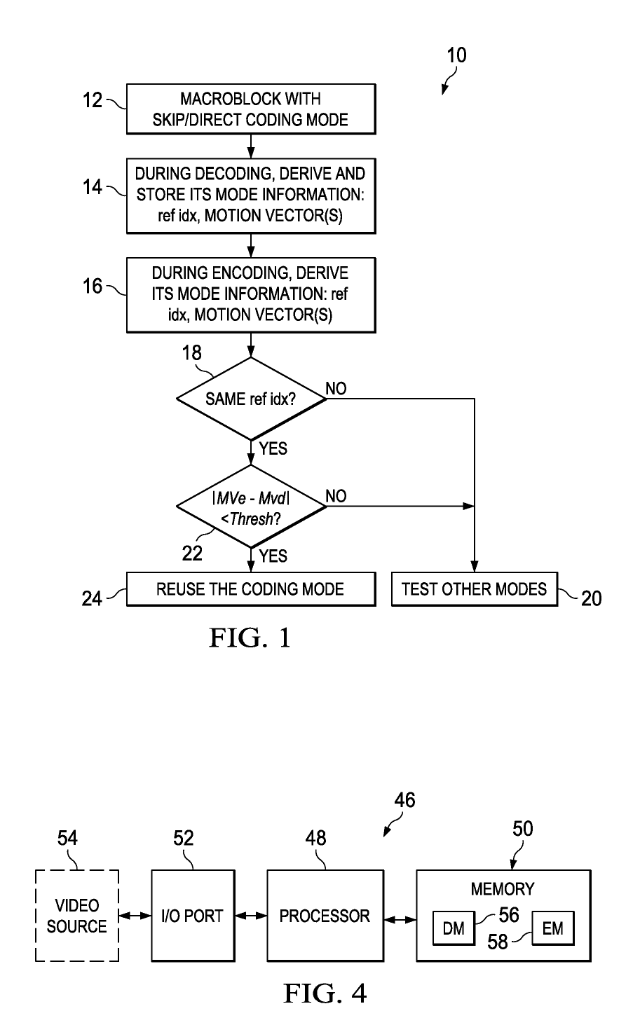

With the understanding of the exception reason, embodiments are described below so that early termination is possible when encoding MBs that are coded in PSkip/BSkip/BDirect modes. Referring now to FIG. 1, a flow diagram 10 depicting an embodiment of a transcoding process is illustrated.

In block 12, a MB with a Skip or Direct coding mode (e.g., PSkip/BSkip/BDirect mode) is provided or encountered in the input bitstream. In block 14, reference frame indices and motion vectors for the MB are derived and recorded (i.e., stored) during the decoding stage. In block 16, reference frame indices and motion vectors are derived from spatial and/or temporal MB neighbors of the MB during the encoding stage.

Thereafter, in block 18, if the reference frame indices recorded during the decoding stage are not the same, or sufficiently similar, as the reference frame indices derived during the encoding stage, then other modes of encoding the bitstream to reduce the bit rate (e.g., P16×16 for a P-frame, B16×16 for a B-frame, etc.) are tested as indicated in block 20. If, however, the reference frame indices recorded during the decoding stage are the same, or sufficiently similar, as the reference frame indices derived during the encoding stage, then the motion vectors are considered in block 22.

In block 22, if an absolute value of a difference between the motion vectors recorded during the decoding stage and the motion vectors derived during the encoding stage exceeds a threshold, then other modes of encoding the bitstream to reduce the bit rate are tested as indicated in block 20. If, however, the absolute value of the difference between the motion vectors recorded during the decoding stage and the motion vectors derived during the encoding stage is less than or equal to the threshold, then the Skip or Direct modes of encoding the bitstream to reduce the bit rate are reused as indicated in block 24.

In an embodiment, the threshold is determined by a number of pixels. For example, for a 1080p resolution the threshold may be 32 pixels. For standard definition (SD) video, which has a resolution of 640×480, the threshold may be 16 pixels. For other video resolutions, other thresholds with more or fewer pixels may be selected. In addition, in some embodiments the threshold may be determined by a parameter other than, or in addition to, a number of pixels.

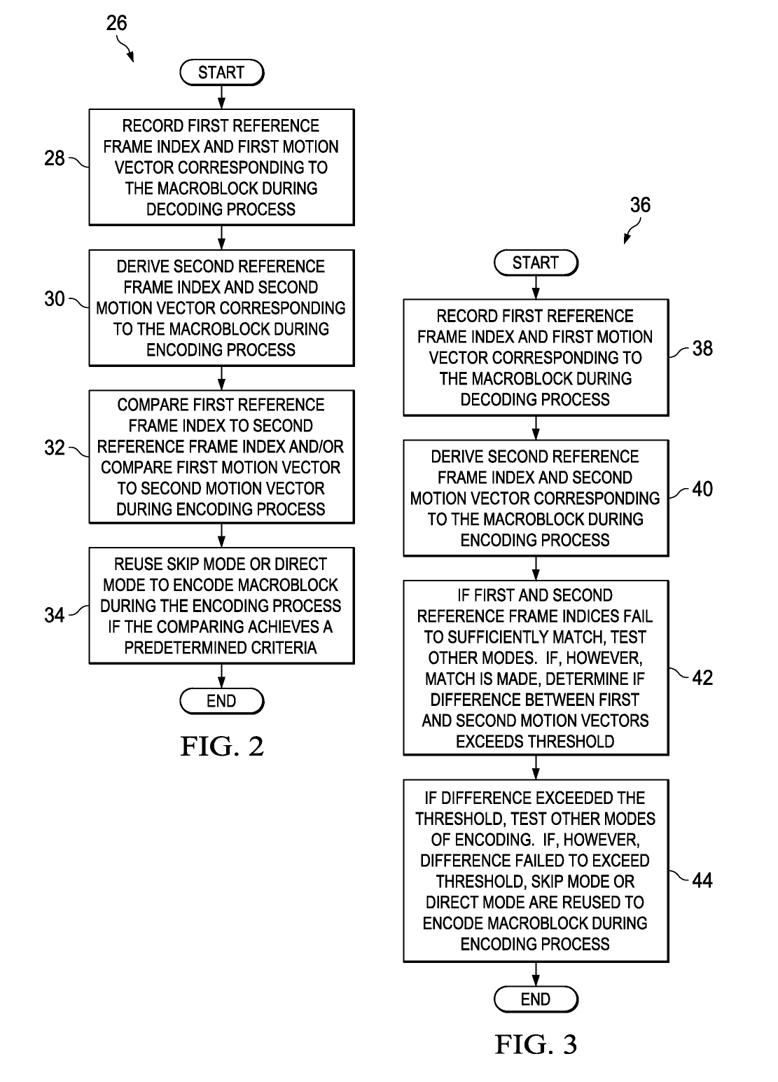

Referring now to FIG. 2, a method 26 of transcoding a MB coded in either a Skip mode or a Direct mode is illustrated. In block 28, a first reference frame index and a first motion vector corresponding to the macroblock are recorded during a decoding process. In block 30, a second reference frame index and a second motion vector corresponding to the macroblock are derived during an encoding process.

In block 32, the first reference frame index is compared to the second reference frame index and/or the first motion vector is compared to the second motion vector during the encoding process. In block 34, the Skip mode or the Direct mode is reused to encode the macroblock during the encoding process if the comparing achieves a predetermined criteria.

Referring now to FIG. 3, a method 36 of method of transcoding a MB coded in either a Skip mode or a Direct mode is illustrated. In block 38, a first reference frame index and a first motion vector corresponding to the macroblock are recorded during a decoding process. In block 40, a second reference frame index and a second motion vector corresponding to the macroblock are derived during an encoding process.

In block 42, if the first reference frame index fails to match the second reference frame index, other modes of encoding are tested. If, however, the first reference frame index matches the second reference frame index, a determination of whether a difference between the first motion vector and the second motion vector exceeds a threshold is made.

In block 44, if the difference exceeded the threshold, the other modes of encoding are tested. If, however, the difference failed to exceed the threshold, the Skip mode or the Direct mode are reused to encode the macroblock during the encoding process.

FIG. 4 illustrates an embodiment processing system 46 that can be utilized to implement methods of the present disclosure. In this case, the main processing is performed in a processor 48, which can be a microprocessor, digital signal processor, or any other appropriate processing device. Program code (e.g., the code implementing the algorithms disclosed above) and data can be stored in a memory 50. The memory 50 can be local memory such as DRAM or mass storage such as a hard drive, optical drive, or other storage (which may be local or remote). While the memory 50 is illustrated functionally with a single block, it is understood that one or more hardware blocks can be used to implement this function.

In one embodiment, the processor 48 can be used to implement various ones (or all) of the functions discussed above. For example, the processor 48 can serve as a specific functional unit at different times to implement the subtasks involved in performing the techniques of the present disclosure. Alternatively, different hardware blocks (e.g., the same as or different than the processor 48) can be used to perform different functions. In other embodiments, some subtasks are performed by the processor 48 while others are performed using a separate circuitry.

FIG. 4 also illustrates an I/O port 52, which can be used to provide the video to and from the processor 48. A video source 54 (the destination is not explicitly shown) is illustrated in dashed lines to indicate that it is not necessary part of the system 46. For example, the video source 54 can be linked to the system 10 by a network such as the Internet or by local interfaces (e.g., a USB or LAN interface).

In an embodiment, a decoding module 56 is loaded in the memory 50. The decoding module 56 is configured to record in the memory 50 a first reference frame index and a first motion vector corresponding to the macroblock when implemented by the processor 48 during the decoding process. In an embodiment, an encoding module 58 is loaded in the memory 50. The encoding module 58 is configured to derive a second reference frame index and a second motion vector corresponding to the macroblock, to compare at least one of the first reference frame index to the second reference frame index and the first motion vector to the second motion vector, and to reuse one of the Skip mode and the Direct mode to encode the macroblock during an encoding process if the comparison achieves a predetermined criteria.

A number of features and benefits can be derived from various embodiments of the present disclosure. For example, in H.264 bit rate reduction transcoding, the motion information of the input bitstream can be utilized during the encoding for the MBs coded in PSkip/BSkip/BDirect modes in the input bitstream. These and additional modes can be checked during their mode decision, where the additional mode checks can be avoided according to certain criteria.

In certain embodiments, for such a MB, motion information derived during the decoding stage, including the reference frame indices and the motion vectors, is recorded and utilized in the encoding stage. In another embodiment, if its reference frames derived both from the decoding stage and the encoding stage are different, the additional modes can be checked. As another embodiment, if its motion vectors derived from the decoding stage and the encoding stage differ more than a predefined threshold for either of their x or y component, the additional modes can be checked.

While the disclosure has been made with reference to illustrative embodiments, this description is not intended to be construed in a limiting sense. Various modifications and combinations of the illustrative embodiments, as well as other embodiments, will be apparent to persons skilled in the art upon reference to the description. It is therefore intended that the appended claims encompass any such modifications or embodiments.

What is claimed is:

1. A method of transcoding a macroblock coded in one of a skip mode and a direct mode, comprising:
recording a first reference frame index and a first motion vector corresponding to the macroblock during a decoding process;
deriving a second reference frame index and a second motion vector corresponding to the macroblock during an encoding process;
comparing at least one of the first reference frame index to the second reference frame index and the first motion vector to the second motion vector during the encoding process; and
reusing one of the skip mode and the direct mode to encode the macroblock during the encoding process if the comparing meets a predetermined criteria.

2. The method of claim 1, wherein the predetermined criteria is whether the first reference frame index matches the second reference frame index.

3. The method of claim 2, further comprising testing other modes of encoding if the first reference frame index does not match the second reference frame index.

4. The method of claim 1, wherein the predetermined criteria is whether a difference between the first motion vector and the second motion vector exceeds a threshold.

5. The method of claim 4, further comprising testing other modes of encoding if the difference between the first motion vector and the second motion vector does not exceed the threshold.

6. The method of claim 4, wherein the threshold is a predefined number of pixels.

7. The method of claim 1, wherein the predetermined criteria is whether an absolute value of a difference between the first motion vector and the second motion vector exceeds a pixel threshold.

8. The method of claim 1, further comprising comparing both the first reference frame index to the second reference frame index and the first motion vector to the second motion vector.

9. The method of claim 8, further comprising comparing the first reference frame index to the second reference frame index prior to comparing the first motion vector to the second motion vector.

10. The method of claim 1, further comprising testing other modes of encoding if the comparing does not meet the predetermined criteria.

11. The method of claim 1, further comprising deriving the second reference frame index and the second motion vector based upon at least one of a spatial macroblock neighbor of the macroblock and a temporal macroblock neighbor of the macroblock.

12. A method of transcoding a macroblock coded in one of a skip mode and a direct mode, comprising:
recording a first reference frame index and a first motion vector corresponding to the macroblock during a decoding process;
deriving a second reference frame index and a second motion vector corresponding to the macroblock during an encoding process;
testing other modes of encoding if the first reference frame index does not match the second reference frame index, and determining if a difference between the first motion vector and the second motion vector exceeds a threshold if the first reference frame index matches the second reference frame index; and
testing the other modes of encoding if the difference exceeded the threshold, and reusing the one of the skip mode and the direct mode to encode the macroblock during the encoding process if the difference failed to exceed the threshold.

13. The method of claim 12, wherein the threshold is a predefined number of pixels.

14. The method of claim 12, further comprising determining if an absolute value of the difference between the first motion vector and the second motion vector exceeds the threshold.

15. The method of claim 12, further comprising storing the first reference frame index and the first motion vector in a memory for subsequent use in the encoding process.

16. The method of claim 12, further comprising deriving the second reference frame index and the second motion vector based upon a spatial macroblock neighbor of the macroblock.

17. The method of claim 12, further comprising deriving the second reference frame index and the second motion vector based upon a temporal macroblock neighbor of the macroblock.

18. The method of claim 12, wherein the decoding process and the encoding process are adapted for a H.264 AVC standard.

19. A transcoding apparatus for transcoding a macroblock code in one of a skip mode and a direct mode, comprising:
a processor;
a storage memory operably coupled to the processor;
a decoding module loaded in the storage memory, the decoding module configured to record in the storage memory a first reference frame index and a first motion vector corresponding to the macroblock during a decoding process; and
an encoding module loaded in the storage memory, the encoding module configured to derive a second reference frame index and a second motion vector corresponding to the macroblock, to compare at least one of the first reference frame index to the second reference frame index and the first motion vector to the second motion vector, and to reuse one of the skip mode and the direct mode to encode the macroblock during an encoding process if the comparison meets a predetermined criteria.

20. The apparatus of claim 19, wherein the encoding module and the decoding module are adapted for a H.264 AVC standard.
